(19) United States
(12) Patent Application Publication
(10) Pub. No.: US 2026/0030084 A1
(43) Pub. Date: Jan. 29, 2026

(54) GENERATING A SPARSE-TREE OF TRIAGE DATA

(71) Applicant: Dell Products L.P., Round Rock, TX (US)

(72) Inventors: Tadd Ottman, Hayward, CA (US); Ziyu Aaron Zhang, Cary, NC (US)

(73) Assignee: Dell Products L.P., Round Rock, TX (US)

(21) Appl. No.: 18/786,710

(22) Filed: Jul. 29, 2024

(51) Int. Cl. G06F 11/07; G06F 11/30

(52) U.S. Cl. CPC G06F 11/0712; G06F 11/3072; G06F 2201/83

(57) ABSTRACT

Methods, system, and non-transitory processor-readable storage medium for a sparse-tree generator are provided herein. An example method includes receiving a structured triage report as input, by a sparse-tree generator, where the structured triage report is generated by a pattern matching engine using, as input, raw triage data. The structured triage report comprises a plurality of files arranged in a directory structure and has an associated structured triage report format. The sparse-tree generator processes the structured triage report to generate as output a sparse-tree of data, where the sparse-tree of data is formatted as suitable input to the pattern matching engine.

### FIELD

The field relates to generating sparse-trees of data, and more particularly to generating sparse-trees of data from structured triage reports in information processing systems.

### BACKGROUND

Automated testing of complex systems commonly generates copious output of data in varying layouts. Technical evaluation of such test data seeks to understand system failures. Evidence of failure is often sparse in the data, requiring expertise to locate, identify, and interpret. Finding and presenting such evidence is called triage, which can be automated. Automated triage aims to produce a concise report of patterns of evidence and failure implications.

### SUMMARY

Illustrative embodiments provide techniques for implementing a sparse-tree generator in a storage system. For example, illustrative embodiments provide a sparse-tree generator that receives a structured triage report as input, where the structured triage report is generated by a pattern matching engine using, as input, raw triage data, and where the structured triage report comprises a plurality of files arranged in a directory structure and has an associated structured triage report format. The sparse-tree generator processes the structured triage report to generate, as output, a sparse-tree of data, where the sparse-tree of data is formatted as suitable input to the pattern matching engine. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including a sparse-tree generator in an illustrative embodiment.

FIG. 2 shows a flow diagram of a process for a sparse-tree generator in an illustrative embodiment.

FIG. 3 illustrates a data flow associated with a pattern matching engine generating a structured triage report, in an illustrative embodiment.

FIG. 4 illustrates a sparse-tree of data as input to a pattern matching engine, in an illustrative embodiment.

FIG. 5 illustrates a sparse-tree generator that omits files with no pattern matches to produce the sparse-tree of data, in an illustrative embodiment.

FIG. 6 illustrates a sparse-tree generator that omits lines in files with no pattern matches to produce the sparse-tree of data, in an illustrative embodiment.

FIGS. 7 and 8 show examples of processing platforms that may be utilized to implement at least a portion of a sparse-tree generator embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a sparse-tree generator, which technique may be used to provide, among other things sparse-tree generation by a sparse-tree generator that receives a structured triage report, as input, where the structured triage report is generated by a pattern matching engine using, as input, raw triage data, where the structured triage report comprises a plurality of files arranged in a directory structure and has an associated structured triage report format. The sparse-tree generator processes the structured triage report to generate, as output, a sparse-tree of data, where the sparse-tree of data is formatted as suitable input to the pattern matching engine.

Although data-driven, automated triage is complex, it needs to be frequently updated to be agile; making frequent updates calls for quick and accurate test cases for the triage engine. Such test cases have been historically very difficult to craft from scratch. Alternatively, selecting and referencing test cases using actual data from automated testing of complex systems tends to be wasteful of disk space, since the actionable evidence in actual data is sparse.

Conventional technologies for storage and use of structured triage data do not provide triage data that can be used to train and/or evaluate a pattern matching engine. Conventional technologies do not provide a method to generate test cases for a pattern matching or triage engine. Conventional technologies do not provide a collection of cases with smaller data sets that span various test scenarios, driving the logic of the triage engine in different ways to achieve good code coverage. Instead, conventional technologies produce structured triage reports that are huge, waste a large amount of storage, are time-consuming to evaluate, and, at the same time, inadequate in exercising the full range of logical possibilities in the triage engine. Conventional technologies require that structured triage reports containing valuable data be archived. These structured triage reports are huge, yet have only a few lines of evidence to justify archiving. Conventional technologies for training models require a large number of cases. These large, structured triage reports are awkwardly big to manipulate, and this restricts the number of cases available for feasible model training. Conventional technologies cannot infer the full layout of the sparse-tree of date because conventional technologies do not use the location of the input files to locate the generated files correctly in the sparse-tree of data.

By contrast, in at least some implementations in accordance with the current technique as described herein, the testing/evaluating of pattern matching engines is optimized by generating sparse-trees of data using a sparse-tree generator that receives a structured triage report as input, where the structured triage report is generated by a pattern matching engine using, as input, raw triage data, where the structured triage report comprises a plurality of files arranged in a directory structure and has an associated structured triage report format. The sparse-tree generator processes the structured triage report to generate, as output, a sparse-tree of data, where the sparse-tree of data is formatted as suitable input to the pattern matching engine.

Thus, a goal of the current technique is to provide a method and a system for a sparse-tree generator that generates a sparse-tree of data out of a structured triage report, where the sparse-tree of data may be used as input to the pattern matching engine, and where the pattern matching engine generated the structured triage report out of raw triage data. Another goal is to provide triage data that can be used to train and/or evaluate a pattern matching engine. Another goal is to provide a method to generate test cases for a pattern matching or triage engine. Another goal is to provide a collection of cases with smaller data sets that span various test scenarios, to drive the logic of the triage engine in different ways to achieve good code coverage. Another goal is to infer the full layout of the sparse-tree of date by using use the location of the input files to locate the generated files correctly in the sparse-tree of data. Yet another goal is to provide sparse-trees of data that exercise the full range of logical possibilities in the triage/pattern matching engine.

In at least some implementations in accordance with the current technique described herein, the use of a sparse-tree generator can provide one or more of the following advantages: providing a method and a system for a sparse-tree generator that generates a sparse-tree of data out of a structured triage report, where the sparse-tree of data may be used as input to the pattern matching engine, providing triage data that can be used to train and/or evaluate a pattern matching engine, providing a method to generate test cases for a pattern matching or triage engine, providing a collection of cases with smaller data sets that span various test scenarios, to drive the logic of the triage engine in different ways to achieve good code coverage, and providing sparse-trees of data that exercise the full range of logical possibilities in the triage/pattern matching engine.

In contrast to conventional technologies, in at least some implementations in accordance with the current technique as described herein, the testing/evaluating of pattern matching engines is optimized by generating sparse-trees of data using a sparse-tree generator that receives a structured triage report as input, where the structured triage report is generated by a pattern matching engine using, as input, raw triage data, where the structured triage report comprises a plurality of files arranged in a directory structure and has an associated structured triage report format. The sparse-tree generator processes the structured triage report to generate as output a sparse-tree of data, where the sparse-tree of data is formatted as suitable input to the pattern matching engine.

In an example embodiment of the current technique, the sparse-tree generator generates test cases for at least one of the pattern matching engine and a second pattern matching engine, where the test cases comprise a plurality of sparse-trees of data.

In an example embodiment of the current technique, the sparse-tree of data is used as input to evaluate at least one of the pattern matching engine and a second pattern matching engine.

In an example embodiment of the current technique, a machine learning model is trained to predict system failures using at least one sparse-tree of data.

In an example embodiment of the current technique, the sparse-tree of data is inputted into at least one of the pattern matching engine and a second pattern matching engine to generate output comprising the associated structured triage report format.

In an example embodiment of the current technique, the associated structured triage report format is not an acceptable format for input into the pattern matching engine.

In an example embodiment of the current technique, the pattern matching engine is at least one of an inference engine, a failure-analysis engine, and a rule-based triage engine.

In an example embodiment of the current technique, the sparse-tree of data is a structured, multiple file signature of a system failure.

In an example embodiment of the current technique, the sparse-tree of data comprises a subset of the plurality of files that are identified by the pattern matching engine as having pattern matches.

In an example embodiment of the current technique, the sparse-tree generator processes the subset of files by retaining only lines in the subset of files that that have pattern matches.

In an example embodiment of the current technique, the sparse-tree generator arranges the subset of files in the sparse-tree of data according to the directory structure associated with the plurality of files.

In an example embodiment of the current technique, the sparse-tree of data comprises a time sequence of operations occurring during automated testing of a system.

In an example embodiment of the current technique, the sparse-tree generator extracts lines in the plurality of files comprising the diagnostic signatures.

In an example embodiment of the current technique, the sparse-tree generator parses the structured triage report, identifies file names in the structured triage report containing diagnostic signatures, where the diagnostic signatures are associated with respective timestamps, identifies relative paths of files associated with the file names containing the diagnostic signatures, and identifies lines in the files associated with the file names containing the diagnostic signatures.

In an example embodiment of the current technique, the sparse-tree generator arranges sparse-tree files in the sparse-tree of data according to the relative paths of the files containing the diagnostic signature.

In an example embodiment of the current technique, the sparse-tree generator arranges sparse-tree lines in the sparse-tree files to maintain a chronological order associated with the respective timestamps.

In an example embodiment of the current technique, the sparse-tree generator creates a set of sparse-tree directories according to the relative paths of files associated with the file names containing the diagnostic signatures, creates a set of sparse-tree files according to the file names containing the diagnostic signatures, populates the set of sparse-tree directories with the set of sparse-tree files, and copies the lines in the files containing the diagnostic signatures into the respective set of sparse-tree files.

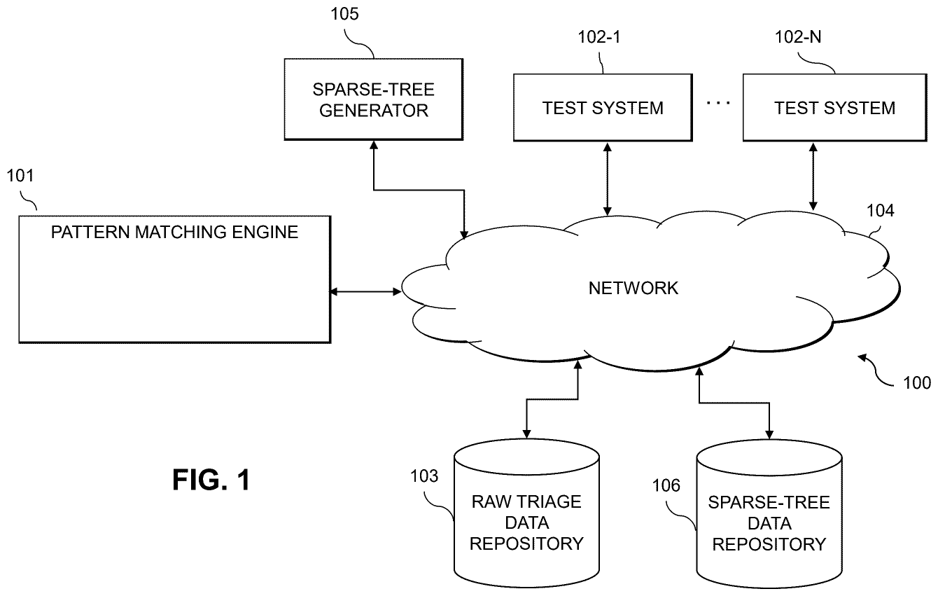

FIG. 1 shows a computer network (also referred to herein as an information processing system) 100 configured in accordance with an illustrative embodiment. The computer network 100 comprises a pattern matching engine 101, sparse-tree generator 105, test systems 102-N, raw triage data repository 103, and sparse-tree data repository 106. The pattern matching engine 101, sparse-tree generator 105, test systems 102-N, raw triage data repository 103, and sparse-tree data repository 106 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a sparse-tree generator 105 that may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the test systems 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The test systems 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the sparse-tree generator 105 are one or more input-output devices, which illustratively comprise keyboards, displays or other types of input-output devices in any combination. Such input-output devices can be used, for example, to support one or more user interfaces to the sparse-tree generator 105, as well as to support communication between the sparse-tree generator 105 and other related systems and devices not explicitly shown. For example, a dashboard may be provided for a user to view a progression of the execution of the sparse-tree generator 105. One or more input-output devices may also be associated with any of the test systems 102-N.

Additionally, the sparse-tree generator 105 in the FIG. 1 embodiment is assumed to be implemented using at least one processing device. Each such processing device generally comprises at least one processor and an associated memory, and implements one or more functional modules for controlling certain features of the sparse-tree generator 105.

More particularly, the sparse-tree generator 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the sparse-tree generator 105 to communicate over the network 104 with the pattern matching engine 101, test systems 102-N, raw triage data repository 103, and sparse-tree data repository 106 and illustratively comprises one or more conventional transceivers.

A sparse-tree generator 105 may be implemented at least in part in the form of software that is stored in memory and executed by a processor, and may reside in any processing device. The sparse-tree generator 105 may be a standalone plugin that may be included within a processing device.

It is to be understood that the particular set of elements shown in FIG. 1 for sparse-tree generator 105 involving the pattern matching engine 101, test systems 102-N, raw triage data repository 103, and sparse-tree data repository 106 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the sparse-tree generator 105 can be on and/or part of the same processing platform.

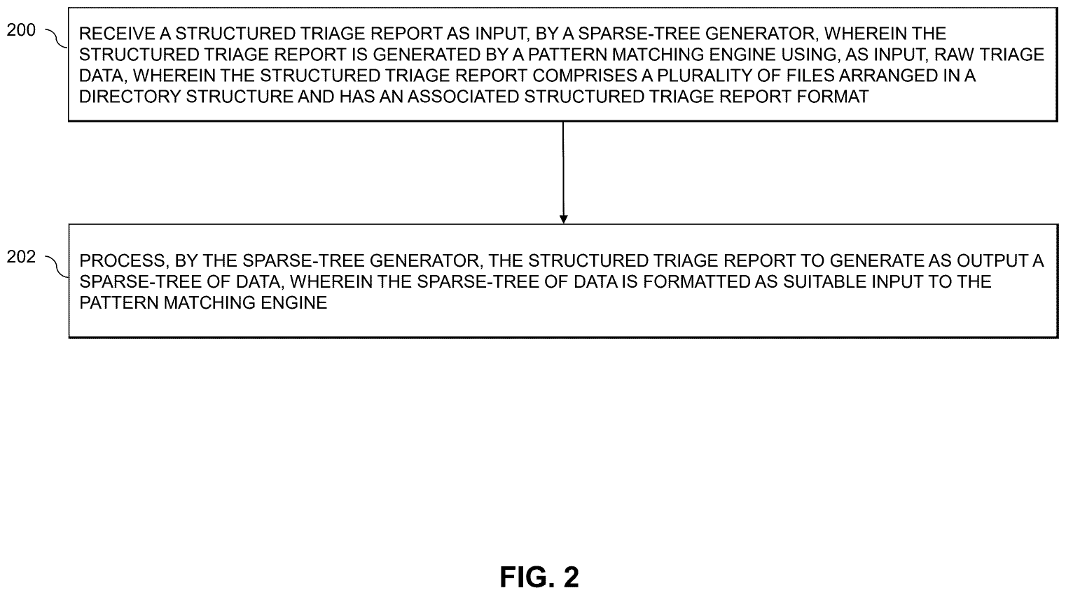

An exemplary process of sparse-tree generator 105 in computer network 100 will be described in more detail with reference to, for example, the flow diagram of FIG. 2.

FIG. 2 is a flow diagram of a process for execution of the sparse-tree generator 105 in an illustrative embodiment. It is to be understood that this particular process is only an example, and additional or alternative processes can be carried out in other embodiments.

At 200, a sparse-tree generator 105 receives a structured triage report as input. The structured triage report is generated by a pattern matching engine 101. Raw triage data is inputted into the pattern matching engine 101 to generate the structured triage report. In an example embodiment, the structured triage report comprises a fixed format.

In an example embodiment, the pattern matching engine 101 is at least one of an inference engine, a failure-analysis engine, and a rule-based triage engine. In an example embodiment, the inference engine may be used not only to analyze data associated with failures, but also to analyze a successful test case so as to have a reference case (in the form of a sparse-tree of data generated by the sparse-tree generator 105) for a passed test case and performance information. In this example embodiment, subsequent executions may reveal, for example, a performance drop when compared to the reference case. In an example embodiment, the failure-analysis engine may be used to identify a root cause of a failure. In this example embodiment, the sparse-tree generator 105 produces a sparse-tree of data suitable for reproducing the failure-analysis report. In an example embodiment, the rule-based triage engine may be used to reduce manual triage efforts. In this example embodiment, the sparse-tree of data generated by the sparse-tree generator 105 is suitable for reproducing the triage report and the associated actions.

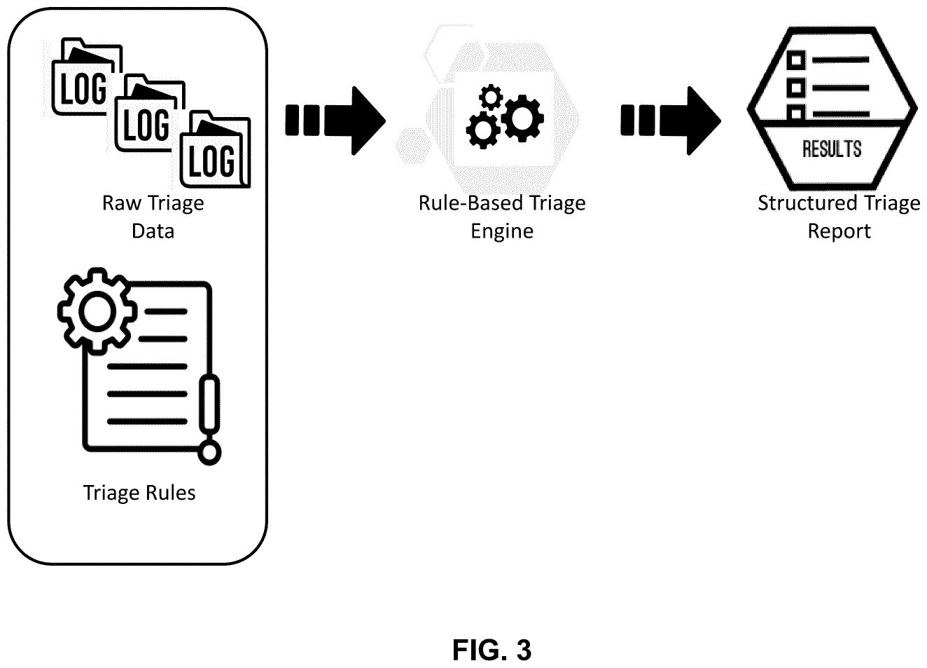

In an example embodiment, the structured triage report comprises a plurality of files arranged in a directory structure and has an associated structured triage report format. FIG. 3 illustrates a data flow associated with a pattern matching engine 101 that generates a structured triage report. In FIG. 3, raw triage data is inputted into a pattern matching engine 101, such as a rules-based tirage engine. The pattern matching engine 101 produces, as output, a structured triage report.

The structured triage report, in a fixed format, provides the name, and relative path of each file containing evidence, and appended to the file name, is a line extracted from the file (associated with the file name) containing a diagnostic signature.

In an example embodiment, the associated structured triage report format generated by the pattern matching engine 101 is not an acceptable format for input into the pattern matching engine 101. In other words, inputting the structured triage report into the pattern matching engine 101 would not produce data in the format of the structured triage report.

At 202, the sparse-tree generator 105 processes the structured triage report to generate as output a sparse-tree of data. The output of the pattern matching engine 101 is a structured triage report. Listed below are snippets of output from a pattern matching engine 101 that is used as input to the sparse-tree generator 105:
>>ndu_pg_upg_fail_3: 1 (symptom matched 1)
ja.log (signature file): Dec 4 10:24:10.870835 (timestamp) FNM00201100271-A (storage product serial number under testing)
postgres_cluster [11601]: [12-1]: user=,db=,app=,client=LOG: database system is shut down (this is the signature line)>
>>STRONSWAN_giving_up_after_three_retransmits: 5
ja.log: Dec 4 10:25:11.093845 FNM00201100271-A cyc_strongswan [61995]: 11 [IKE]<host-host-v6|2>giving up after 3 retransmits
>>kernel_panic_cgroup_out_of_memory: 1
ja.log: Dec 5 03:04:49.885192 FNM00201100271-A kernel:
mem_cgroup_out_of_memory+0xb9/0xd0

In an example embodiment, the sparse-tree of data is a structured, multiple file signature of a system failure. In an example embodiment, the sparse-tree generator 105 utilizes a structured triage report to infer the location, identity, content, and layout of sparse evidence from the original test data, such that a sparse-tree of data can be generated. In an example embodiment, the contents of the structured triage report are not sufficient to infer the full layout of the sparse-tree of data. The output of the pattern matching engine 101 contains file names, locations, line numbers and signature lines that match at least one rule associated with the pattern matching engine 101. In an example embodiment, the sparse-tree generator 105 uses the location of the input files to position the generated files in the sparse-tree of data correctly within the sparse-tree of data. In other words, the sparse-tree generator 105 leverages the structured triage report, including all the files and folder structure to create the sparse-tree of data. The sparse-tree of data is a subset of the data in the structured triage report. This subset of data will generate the same output when analyzed by the pattern matching engine 101 as the raw triage report would when analyzed by the pattern matching engine 101. Yet, the sparse-tree of data is much smaller than the bloated structured triage report (produced by the pattern matching engine 101), and therefore, the sparse-tree of data is more efficient for storing in a sparse-tree data repository 106 for testing.

In an example embodiment, the sparse-tree generator 105 recreates the folder structure, with the signature files in their original locations. In an example embodiment, the signature files will only contain the signature lines. However, the sparse-tree of data will still generate the same triage results when used as input to the pattern matching engine 101 because the sparse-tree of data contains all the signature files and signature lines.

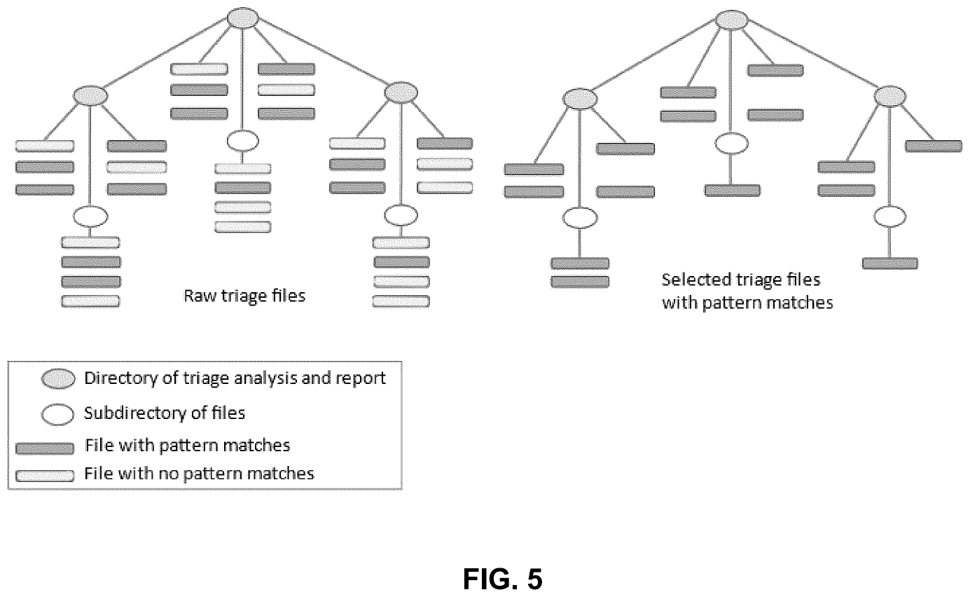

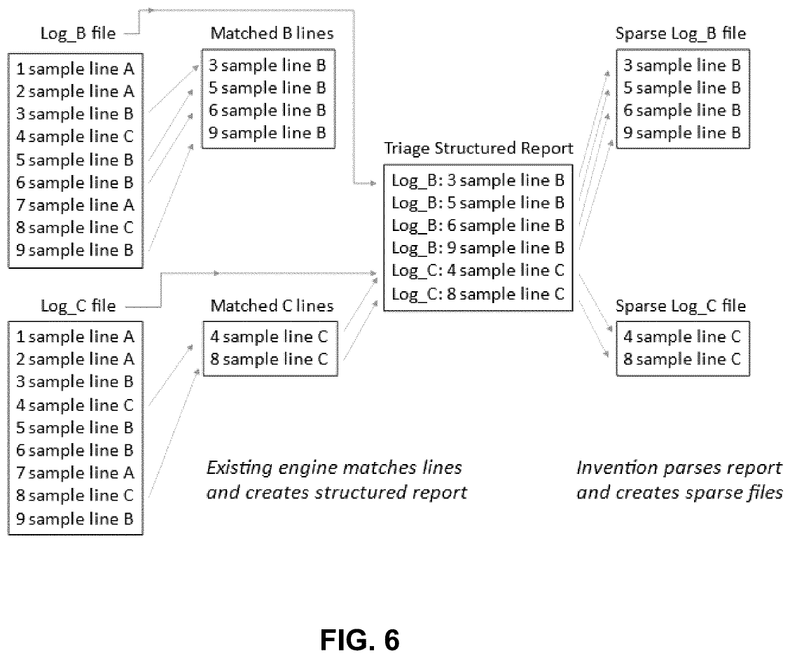

In an example embodiment, the sparse-tree of data is populated by fewer files than the original structured triage report since the sparse-tree of data only contains files that have pattern matches, or “hotspots”. In an example embodiment, the individual files in the sparse-tree of data have fewer lines than the original structured triage report, since the sparse-tree of data only contain lines that have signature pattern matches, also called diagnostic snippets. FIG. 5 illustrates how the sparse-tree of data omits files with no pattern matches (yet preserving the layout) to produce a sparse-tree of files. FIG. 6 illustrates how the sparse-tree of data omits lines with no pattern matches (yet preserving line order) to produce a sparse-file of line.

In an example embodiment, sparse-trees of data manifest hotspot maps of evidence found in the huge sets of raw data, and hotspot maps offer small, yet rich, pre-digested representations of complex system failures for data scientists to ingest, for example, with models of artificial intelligence. In an example embodiment, the sparse-tree of data is a structured, multiple-file signature of a system failure, and can be used to reproduce a system failure. In an example embodiment, one sparse-tree of data would be 1 to 1 with a system failure.

In an example embodiment, the sparse-tree of data is formatted as suitable input to the pattern matching engine 101. In other words, the output of the sparse-tree generator 105 can be used as input to the pattern matching engine 101, generating the structured triage report format. Yet, the structured triage report generated by the pattern matching engine 101 cannot be used as input to the pattern matching engine 101. The sparse-tree of data is relatively tiny, yet it contains all of the evidence that the pattern matching engine 101 requires to reproduce an accurate report from the data in the sparse-tree of data, should the sparse-tree of data be entered as input into the pattern matching engine 101. In other words, sparse-trees of data make for small and quick test cases for the pattern matching engine 101. Listed below are examples of the size of the raw triage date, the structured triage report, and the sparse-tree of data:

| | | |
|---|---|---|
| Raw triage | Structured | Sparse-tree |
| data size | triage report size | of data size |

| | | | | | |
|---|---|---|---|---|---|
| 3.1 | MB | 40 | KB | 386 | bytes |
| 2.7 | GB | 11 | MB | 16 | KB |
| 6.9 | GB | 2.3 | MB | 2155 | bytes |
| 21.7 | GB | 63 | MB | 41 | KB |
| 22 | GB | 152 | MB | 17.6 | KB |
| 25 | GB | 16 | MB | 40 | KB |
| 47 | GB | 33 | MB | 24 | KB |
| 502 | GB | 3.2 | GB | 668 | KB |

In an example embodiment, the sparse-tree of data can be used as input into the pattern matching engine 101, or a second (or third, or fourth, etc.) pattern matching engine 101 to generate output that comprises the associated structured triage report format. Thus, in an example embodiment, the sparse-tree generator 105 generates test cases for the pattern matching engine 101, or a second (or third, or fourth, etc.) pattern matching engine where the test cases comprise a plurality of sparse-trees of data. Thus, in an example embodiment, the sparse-tree of data may be used as input to evaluate one or more pattern matching engines. In another example embodiment, one or more sparse-tree of data may be used to train a machine learning model to predict system failures using at least one sparse-tree of data. In an example embodiment, the processing time of a pattern matching engine 101 using a sparse-tree of data as input is also optimized as illustrated below:

| Original Raw triage data scan time | Sparse-tree of data scan time |
|---|---|
| 00:00:08 | 00:00:07 |
| 00:00:44 | 00:00:18 |
| 00:00:51 | 00:00:28 |
| 00:05:08 | 00:00:27 |
| 00:07:12 | 00:00:17 |
| 00:01:31 | 00:00:16 |
| 00:01:26 | 00:00:07 |
| 10:11:52 | 00:00:45 |

In an example embodiment, the sparse-tree of data comprises a subset of the plurality of files that are identified by the pattern matching engine 101 as having pattern matches. In an example embodiment, the pattern matching engine 101 has a set of rules that are applied to the raw triage data to generate the structured triage report. The structured triage report can be a very large file.

In an example embodiment, the sparse-tree generator 105 processes the subset of files by retaining only lines in the subset of files that that have pattern matches. In an example embodiment, the sparse-tree generator 105 arranges the subset of files in the sparse-tree of data according to the directory structure associated with the plurality of files. In an example embodiment, the sparse-tree of data comprises a time sequence of operations occurring during automated testing of a system.

In an example embodiment, the sparse-tree generator 105 parses the fixed format of the structured triage report, infers the layout of the files, reads the file names, and populates the contents of sparse-trees of data with the lines containing the diagnostic signatures recorded in the structured triage report. The sparse-tree of data generated by the sparse-tree generator 105 comprises the correct files, in the expected locations, containing the diagnostic signature lines in the original order, reflecting the time sequence of operations that occurred during an automated testing of a complex system.

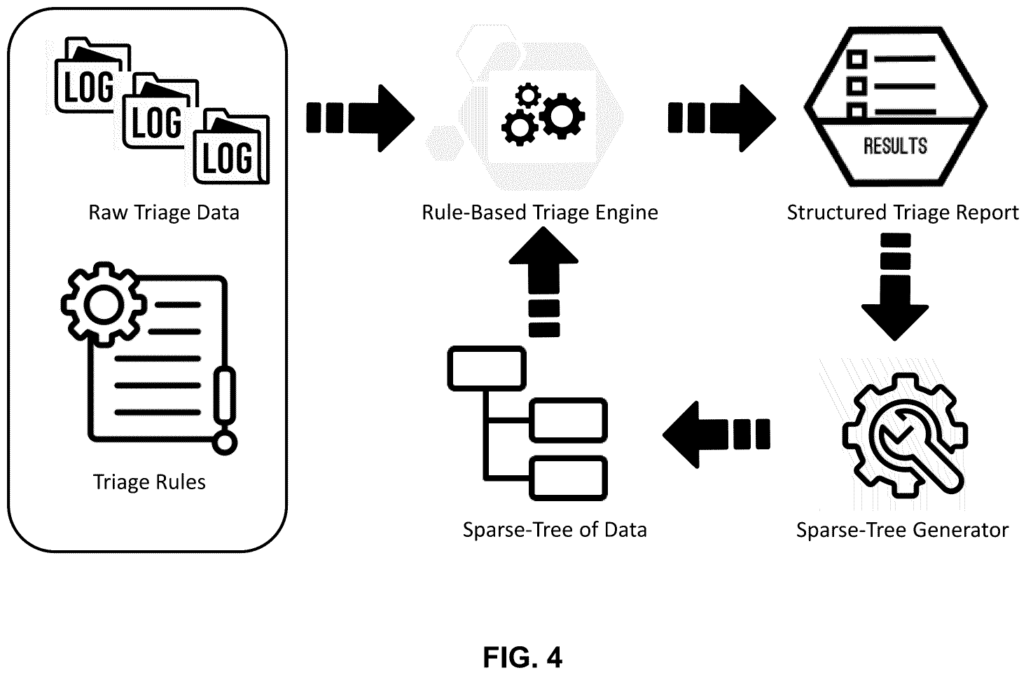

In an example embodiment, the sparse-tree generator 105 extracts lines in the plurality of files comprising the diagnostic signatures. In an example embodiment, the sparse-tree generator 105 parses the structured triage report, identifying file names in the structured triage report containing diagnostic signatures. In an example embodiment, the diagnostic signatures are associated with respective timestamps. The sparse-tree generator 105 identifies relative paths of files associated with the file names containing the diagnostic signatures, and then identifies lines in the files associated with the file names containing the diagnostic signatures. In an example embodiment, the sparse-tree generator 105 then arranges the sparse-tree files in the sparse-tree of data according to the relative paths of the files containing the diagnostic signature. In an example embodiment, the sparse-tree generator 105 arranges sparse-tree lines in the sparse-tree files to maintain a chronological order associated with the respective timestamps. More specifically, the sparse-tree generator 105 arranges the sparse-tree lines in the correct sparse-tree files, maintaining the chronological order associated with the timestamps that are associated with the diagnostic signatures to create compact sparse-tree of data that are suitable for input into one or more pattern matching engines 101, driving the rules associated with the pattern matching engine 101 to produce output that has the structured triage report format. Thus, the output of the sparse-tree generator 105 can be used to evaluate one or more pattern matching engines 101 and/or train a machine learning model to predict failures in complex systems. In an example embodiment, the sparse-trees of data may be stored in a sparse-tree data repository 106, providing the data associated with the testing of complex systems, where the data is provided and stored in a concise, compact format. FIG. 4 illustrates how the generated sparse-tree of data may be used as input, as a test case for the pattern matching engine 101. In an example embodiment, if the input rules associated with the pattern matching engine 101 are unchanged, inputting the sparse-tree of data into the pattern matching engine 101, produces the same structured triage report format as produced by the pattern matching engine 101 when the raw triage data is inputted into the pattern matching engine 101.

In an example embodiment, the sparse-tree generator 105 creates a set of sparse-tree directories according to the relative paths of files associated with the file names containing the diagnostic signatures, and then creates a set of sparse-tree files according to the file names containing the diagnostic signatures. The sparse-tree generator 105 then populates the set of sparse-tree directories with the set of sparse-tree files, and copies the lines in the files containing the diagnostic signatures into the respective set of sparse-tree files.

Accordingly, the particular processing operations and other functionality described in conjunction with the flow diagram of FIG. 2 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to generate sparse-trees of data using a sparse-tree generator that receives a structured triage report as input, where the structured triage report is generated by a pattern matching engine using as input raw triage data. These and other embodiments can effectively improve testing and evaluation of pattern matching engines and training of models relative to conventional approaches. For example, embodiments disclosed herein provide triage data that can be used to train and/or evaluate a pattern matching engine. Embodiments disclosed herein provide a method to generate test cases for a pattern matching or triage engine. Embodiments disclosed herein provide a collection of cases with smaller data sets that span various test scenarios, driving the logic of the triage engine in different ways to achieve good code coverage. Embodiments disclosed herein infer the full layout of the sparse-tree of date by using use the location of the input files to locate the generated files correctly in the sparse-tree of data.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

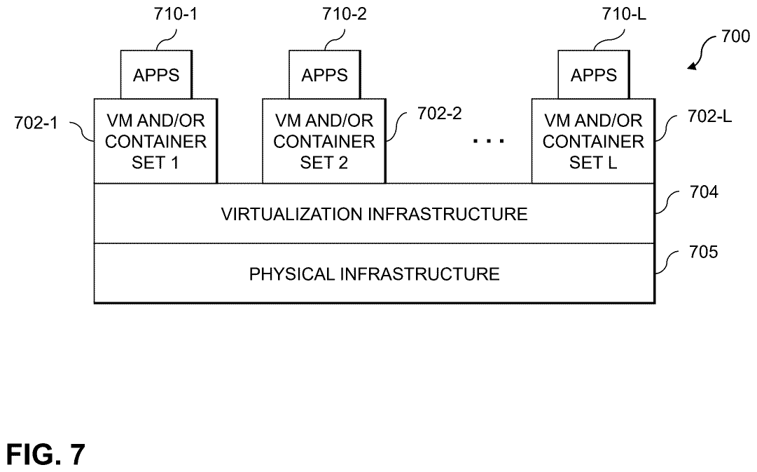

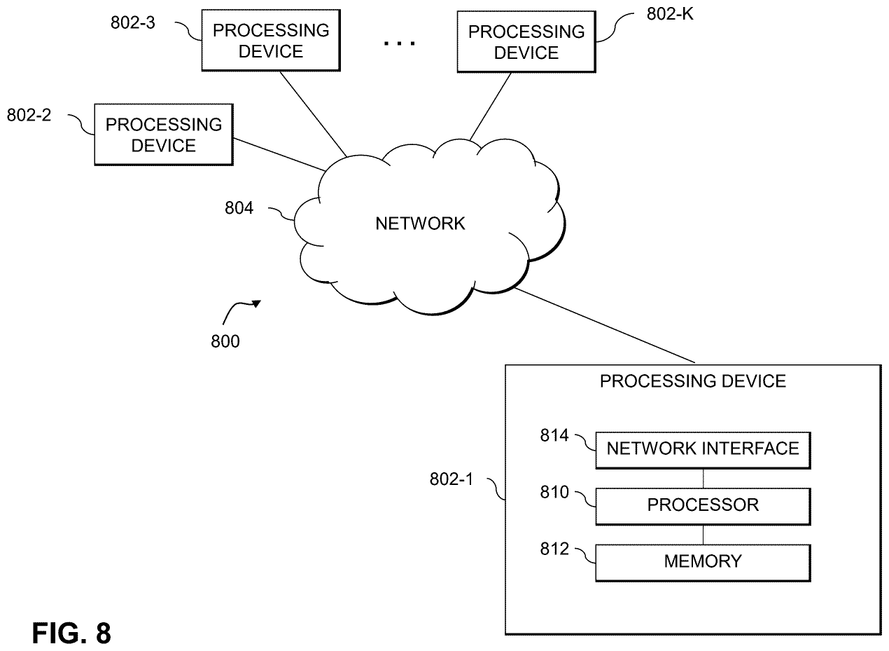

Illustrative embodiments of processing platforms will now be described in greater detail with reference to FIGS. 7 and 8. Although described in the context of the information processing system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, where the hypervisor platform has an associated virtual infrastructure management system. The underlying physical machines comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of the information processing system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, a microcontroller, an application-specific integrated circuit (ASIC), a field-programmable gate array (FPGA) or other type of processing circuitry, as well as portions or combinations of such circuitry elements.

The memory 812 comprises random access memory (RAM), read-only memory (ROM) or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving a structured triage report as input, by a sparse-tree generator, wherein the structured triage report is generated by a pattern matching engine using, as input, raw triage data, wherein the structured triage report comprises a plurality of files arranged in a directory structure and has an associated structured triage report format; and
processing, by the sparse-tree generator, the structured triage report to generate as output a sparse-tree of data, wherein the sparse-tree of data is formatted as suitable input to the pattern matching engine, wherein the method is performed by at least one processing device comprising a processor coupled to a memory.

2. The method of claim 1 further comprising:
generating, by the sparse-tree generator, test cases for at least one of the pattern matching engine and a second pattern matching engine, wherein the test cases comprise a plurality of sparse-trees of data.

3. The method of claim 1 further comprising:
utilizing the sparse-tree of data as input to evaluate at least one of the pattern matching engine and a second pattern matching engine.

4. The method of claim 1 further comprising:
training a machine learning model to predict system failures using at least one sparse-tree of data.

5. The method of claim 1 wherein receiving the structured triage report as input, by the sparse-tree generator comprises:
inputting the sparse-tree of data into at least one of the pattern matching engine and a second pattern matching engine generates output comprising the associated structured triage report format.

6. The method of claim 1 wherein the associated structured triage report format is not an acceptable format for input into the pattern matching engine.

7. The method of claim 1 wherein the pattern matching engine is at least one of an inference engine, a failure-analysis engine, and a rule-based triage engine.

8. The method of claim 1 wherein the sparse-tree of data is a structured, multiple file signature of a system failure.

9. The method of claim 1 wherein the sparse-tree of data comprises a subset of the plurality of files that are identified by the pattern matching engine as having pattern matches.

10. The method of claim 9 wherein the sparse-tree generator processes the subset of files by retaining only lines in the subset of files that that have pattern matches.

11. The method of claim 1 wherein the sparse-tree generator arranges the subset of files in the sparse-tree of data according to the directory structure associated with the plurality of files.

12. The method of claim 1 wherein the sparse-tree of data comprises a time sequence of operations occurring during automated testing of a system.

13. The method of claim 1 wherein processing, by the sparse-tree generator, the structured triage report to generate as output the sparse-tree of data comprises:
extracting, by the sparse-tree generator, lines in the plurality of files comprising the diagnostic signatures.

14. The method of claim 1 wherein processing, by the sparse-tree generator, the structured triage report to generate as output the sparse-tree of data comprises:
parsing, by the sparse-tree generator, the structured triage report;
identifying, by the sparse-tree generator, file names in the structured triage report containing diagnostic signatures, wherein the diagnostic signatures are associated with respective timestamps;
identifying, by the sparse-tree generator, relative paths of files associated with the file names containing the diagnostic signatures; and
identifying, by the sparse-tree generator, lines in the files associated with the file names containing the diagnostic signatures.

15. The method of claim 14 further comprising:
arranging, by the sparse-tree generator, sparse-tree files in the sparse-tree of data according to the relative paths of the files containing the diagnostic signature.

16. The method of claim 14 further comprising:
arranging, by the sparse-tree generating, sparse-tree lines in the sparse-tree files to maintain a chronological order associated with the respective timestamps.

17. The method of claim 14 further comprising:
creating, by the sparse-tree generator, a set of sparse-tree directories according to the relative paths of files associated with the file names containing the diagnostic signatures;
creating, by the sparse-tree generator, a set of sparse-tree files according to the file names containing the diagnostic signatures;
populating, by the sparse-tree generator, the set of sparse-tree directories with the set of sparse-tree files; and
copying, by the sparse-tree generator, the lines in the files containing the diagnostic signatures into the respective set of sparse-tree files.

18. A system comprising:
at least one processing device comprising a processor coupled to a memory;
the at least one processing device being configured:
to receive a structured triage report as input, by a sparse-tree generator, wherein the structured triage report is generated by a pattern matching engine using, as input, raw triage data, wherein the structured triage report comprises a plurality of files arranged in a directory structure and has an associated structured triage report format; and
to process, by the sparse-tree generator, the structured triage report to generate as output a sparse-tree of data, wherein the sparse-tree of data is formatted as suitable input to the pattern matching engine.

19. The system of claim 18 further configured to:
train a machine learning model to predict system failures using at least one sparse-tree of data.

20. A computer program product comprising a non-transitory processor-readable storage medium having stored therein program code of one or more software programs, wherein the program code when executed by at least one processing device causes said at least one processing device:
to receive a structured triage report as input, by a sparse-tree generator, wherein the structured triage report is generated by a pattern matching engine using, as input, raw triage data, wherein the structured triage report comprises a plurality of files arranged in a directory structure and has an associated structured triage report format; and
to process, by the sparse-tree generator, the structured triage report to generate as output a sparse-tree of data, wherein the sparse-tree of data is formatted as suitable input to the pattern matching engine.
